(19) United States
(12) Patent Application Publication
(10) Pub. No.: US 2012/0063983 A1
(43) Pub. Date: Mar. 15, 2012

(54) Method for Synthesis of Boron Nitride Nanopowder

(75) Inventors: Nugzar Valerianovich Dvali, Tbilisi (GE); Jasha Mihailovich Tabatadze, Tbilisi (GE); Oleg Lvovich Figovsky, Haifa (IL)

(73) Assignees: POLYMATE, LTD.; MALAXIT, LTD.

(21) Appl. No.: 12/879,959

(22) Filed: Sep. 10, 2010

(51) Int. Cl. C01B 21/064

(52) U.S. Cl. 423/290; 977/773; 977/775; 977/840

(57) ABSTRACT

A reaction is carried in a gaseous phase between ammonia (NH₃) and boron trifluoride (BF₃) in a cooled reactor under atmospheric pressure. A boron trifluoride-ammonia complex (NH₃.BF₃) obtained in this reaction is thermally decomposed at a temperature in the range of 125 to 300° C. into boron nitride and ammonium tetrafluoroborate in accordance with the following scheme:
125-300° C.

4NH₃.BF₃→BN+3NH₄.BF₄

BN is then separated from the mixture of BN with 3NH₄.BF₄ by combining the mixture with deionized water, forming a suspension, and separating the suspended BN nanoparticles by centrifugation.

### FIELD OF THE INVENTION

The present invention relates to a novel method for synthesis of a nanopowder of boron nitride (herein after referred to as BN) obtained by thermal decomposition of an NH₃.BF₃ complex.

### BACKGROUND OF THE INVENTION

Boron nitride is a chemical compound with chemical formula BN. This compound has equal numbers of boron and nitrogen atoms. Since boron nitride is isoelectronic to a similarly structured carbon lattice, it may exist in various crystalline forms. The most stable is the hexagonal form that corresponds to graphite, and the softest are boron nitride polymorphs, which are used as a lubricants and an additive to cosmetic products. The cubic variety of the boron nitride, which is analogous to diamond, is known as c-BN. Its hardness is inferior only to diamond, but its thermal and chemical stability is superior.

BN is one of the most important non-oxide ceramic materials. Boron nitride does not exist in nature but can be synthesized by various methods.

One of methods for synthesis of boron nitride is described by G.V. Samsonov in Non-metallic Nitrides, Metallurgia Publishers, Moscow, 1969, p. 121. According to this method, the technological process involves the following steps:

1. Mixing of chalk (CaCO₃) and boric acid (H₃BO₃) [first charge];

2. Heating of obtained charge up to 1000-2000° C.;

3. Grinding of obtained caked mass;

4. Screening of the powder;

5. Mixing of the powder and ammonium chloride [second charge];

6. Nitration of second charge by ammonia and preparation of the BN+CaO mixture;

7. Washing of BN and CaO by hydrochloric acid (HCl);

8. Drying and packing of dried powder of BN.

As shown, the method is time-consuming, and requires high temperatures and the use of special equipment; hence, it is expensive.

As can be seen from the Gmelin Handbook of Inorganic Chemistry (Anton Meller, Gmelin Handbook of Inorganic Chemistry, B 3^{rd} Supplement, Vol. 3, 1988, p. 1-7, Springer-Verlag, West Berlin, Germany), chemical components from which boron nitride may be produced require special pre-treatment and can be synthesized at high temperature conditions that cause corrosion of the reactor materials and contaminate the final product. Manufacturing of boron nitride by traditional high-temperature methods, however, imparts to a product a hexagonal structure that makes the material non-compressible. Without the use of binding components (which impair properties of boron nitride products), it is difficult to produce samples of high density and compactness. (See aforementioned reference to G. V. Samsonov).

Chinese Unexamined Patent Application Publication CN1539729 (Xu Xiaowei, et al.) published on Oct. 27, 2004, discloses a process for preparing boron nitride from boron trifluoride ether and lithium nitride by solvent heat synthesis. The method includes adding benzene to the reactor as solvent, adding lithium nitride, stirring, adding boron trifluoride ether, stirring, closing the reactor, heating the content to 250-500° C., holding the temperature for a predetermined time, cooling the product, and dissolving it in deionized water. A supernatant is then subjected to centrifugal separation, the dissolving and separation steps are repeated, the product is immersed into a solution of hydrochloric acid, washed with water, the deposit is centrifugally separated, and the product is dried. In this method, boron nitride is obtained together with lithium fluoride because of an exchange reaction. Since the lithium fluoride produced in this process is poorly soluble in water, purification of the target product presents a problem.

U.S. Pat. No. 5,169,613 issued on Dec. 8, 1992, to Sheldon Shore, et al., describes synthesis of ammonia-haloboranes (and in particular, H₃NBH₂Cl) which are useful for the production of amorphous boron nitride and crystalline boron nitride by heating. Boranes that are used as starting materials for synthesis, however, are strongly hydroscopic and very toxic substances. Therefore, the method that uses such starting material requires extreme caution and safety measures.

In view of the above, a demand exists for new, reliable, safe, and simple methods for synthesis of a boron nitride nanopowder.

### SUMMARY OF THE INVENTION

The method of the present invention comprises the following steps: obtaining a white friable powder of an boron trifluoride-ammonia complex (NH₃.BF₃) by conducting a reaction between gaseous ammonia substances (NH₃) and a boron trifluoride (BF₃), the reaction being carried out in a cooled reactor under atmospheric pressure; obtaining boron nitride and ammonium tetrafluoroborate by thermally decomposing the obtained boron trifluoride-ammonia complex (NH₃.BF₃) at a temperature above 125° C. in accordance with the following scheme:
t>125° C.

4NH₃.BF₃→BN+3NH₄.BF₄

and separating boron nitride from ammonium tetrafluoroborate.

Separation of the BN from the obtained mixture of BN with ammonium tetrafluoroborate may be carried out, e.g., by combining the mixture with deionized water, forming a suspension of mixture particles, and separating particles of BN from 3NH₄.BF₄ by centrifugation.

A starting material for the synthesis comprises boron trifluoride (BF₃) and ammonia (NH₃).

Boron trifluoride (BF₃) is a colorless gas with a clearly detectable odor, a melting point of −128° C., and a boiling point of −101° C. The gaseous boron nitride (BF₃) can be well hydrolyzed with steam to form a boric acid (H₃BO₃) and fluoroboric acid (HBF₄).

4BF₃+3NH₃=H₃BO₃+3HBF₄

Based on a phenomenon that when the boron trifluoride is used in excess, the hydrolysis products (H₃BO₃+3HBF₄) form a mist over the reactor exit, this reaction can be used for controlling synthesis of the NH₃.BF₃complex. This is because the use of BF₃ in excess generates a mist that consists of the products of hydrolysis (i.e., H₃BO₃ and HBF₄) above the reactor exit. In order to adjust the process to normal, it is necessary either to reduce the flow of BF₃ or to increase the flow of NH₃ until the mist disappears. Such an adjustment makes it possible to reduce the loss of BF₃ and to increase the yield of the NH₃.BF₃ complex.

Ammonia (NH₃) is a colorless gas with a characteristic pungent odor, a boiling point of −33.5° C., and a melting point of −77.75° C.

A reactor used for synthesis comprises a sealed metal vessel, the inner surface of which is coated with a thin layer of TEFLON. The reactor has a water-cooling jacket and a cover. The reactor cover is provided with three tubes, two of which are used for the supply of gaseous starting materials in the form of NH₃ and BF₃, and the third tube is intended for the supply of inert gas, e.g., nitrogen. The inert gas is used as a carrier that prevents clogging of the gas-inlet tubes by the products of synthesis.

Inlet and outlet pipes of the reactor are manufactured from boron nitride, which is inert in relation to boron trifluoride and ammonia, preventing the contamination of synthesized complex of boron triflluoride-ammonia by impurities.

### DETAILED DESCRIPTION OF THE INVENTION

The present invention relates to a novel method for manufacturing a nanopowder of boron nitride (herein after referred to as BN) obtained by thermal decomposition of NH₃.BF₃.

A first step of the method of the invention comprises conducting a reaction between gaseous ammonia substances (NH₃) and a boron trifluoride (BF₃), the reaction being carried out in a cooled reactor under atmospheric pressure. The reaction produces a boron trifluoride-ammonia complex (NH₃.BF₃) that comprises white friable powder which is stable in air at room temperature. The next step is heating of the obtained boron trifluoride-ammonia complex (NH₃.BF₃) at a temperature in the range of 125 to 300° C. for thermal decomposition of the complex into boron nitride and ammonium tetrafluoroborate in accordance with the following scheme:
125-300° C.

4NH₃.BF₃→BN+3NH₄.BF₄

Decomposition of the complex (NH₃.BF₃) can be carried out in air, in the atmosphere of an inert gas, or under a reduced pressure.

As has been confirmed by the results of X-ray and thermogravimetric analyses, at temperatures below 125° C., the 4NH₃.BF₃ does not decompose. If thermal decomposition is carried out at temperatures that exceed 300° C., however, the process is accompanied by evaporation of residual NH₄BF₄ that is generated in the decomposition reaction. The products of evaporation entrap particles of the target product (BN) and reduce the yield of the latter.

The BN obtained as a result of decomposition of the 4NH₃.BF₃ complex comprises a white powder with an average particle size in the range of 2 to 3 nm. This was confirmed by the results of X-ray phase analysis and electron microscope measurements. These analysis and observations showed that, in addition to high dispersion, the obtained BN powder has an imperfect (X-ray amorphous) crystalline structure. Such properties impart to the BN obtained by the method of the invention a possibility of recrystallization and improved conditions for sintering the powder into a sintered product.

The use of the process described above for obtaining BN is superior to conventional processes for the following reasons:
1. Ammonia (NH₃) and boron trifluoride (BF₃) are commercially produced, inexpensive, and readily available components for synthesis of BN.
2. These reagents do not need any preliminary chemical treatment, and the boron trifluoride-ammonia complex (NH₃.BF₃), which constitutes a starting material for synthesis of boron nitride, is obtained by direct connection of two components, i.e., NH₃ and BF₃.
3. The gaseous phase of the reagents makes it possible to adjust the speed of the synthesis reaction, and hence, the amount of the obtained product.
4. The obtained complex (NH₃.BF₃) is thermally unstable and, when heated above 125° C., is decomposed into two components, BN and NH₄BF4 (ammonium tetrafluoroborate). The latter is easily soluble in water, simplifying purification of the final product.
5. The imperfect crystalline structure of the obtained BN makes it suitable for recrystallization and sintering.
6. The obtained BN is highly dispersible.

The invention will be further described by way of practical and comparative examples.

### EXAMPLES

### Practical Example 1

A 2-liter reactor, which was cooled with a flow of water, was loaded with gaseous BF₃ and gaseous NH₃ supplied simultaneously in equal volumes at a flow rate of 0.7 liter/min. The reaction was carried out in the cooled reactor for 3 hours under the atmospheric pressure, whereby 650 g of a white, friable powder was obtained. The obtained complex was subjected to X-ray analysis that confirmed that the product comprised an NH₃.BF₃ complex.

The obtained 650 g of the powdered NH₃.BF₃ complex were loaded into a beaker made from a pyrolytic graphite, and the beaker was inserted into a stainless-steel container, which, in turn, was placed into an oven (thermostat) heated to 125° C. wherein the container was kept for 5 hours in air under atmospheric conditions. Following this, the container was cooled to room temperature, and the product of the complex decomposition was extracted and subjected to X-ray phase analysis. The analysis confirmed that the product of decomposition comprised a mixture of BN and ammonium fluoroborate (NH₄BF₄). This mixture was transferred to a 10-liter capacity polypropylene container where the mixture was combined with 9500 g of deionized water, whereby an aqueous suspension was formed.

Suspended particles contained in the suspension were caused to precipitate by centrifugation and dried. The resulting product comprised 17.03 g of BN obtained with 81% yield relative to the theoretical value. Results of X-ray analysis and measurements made with the use a scanning electron microscope showed that the obtained powder had an average particle diameter in the range of 2 to 3 nm.

### Practical Example 2

A 2-liter reactor, which was cooled with a flow of water, was loaded with gaseous BF₃ and gaseous NH₃ supplied simultaneously in equal volumes at a flow rate of 0.7 liter/min. The reaction was carried out in the cooled reactor for 3 hours under the atmospheric pressure, whereby 650 g of a white, friable powder was obtained. The obtained complex was subjected to X-ray analysis that confirmed that the product comprised an NH₃.BF₃ complex.

The obtained 650 g of the powdered NH₃.BF₃ complex were loaded into a beaker made from a pyrolytic graphite, and the beaker was inserted into a stainless-steel container, which, in turn, was placed into an oven (thermostat) heated to 200° C. wherein the container was kept for 5 hours in air under atmospheric conditions. Following this, the container was cooled to room temperature, the product of the complex decomposition was extracted and subjected to X-ray phase analysis. The analysis confirmed that the product of decomposition comprised a mixture of BN and ammonium fluoroborate (NH₄BF₄). This mixture was transferred to a 10-liter capacity polypropylene container where the mixture was combined with 9500 g of deionized water, whereby an aqueous suspension was formed.

Suspended particles were caused to precipitate by centrifugation and dried. The resulting product comprised 18.93 g of BN obtained with 90% yield relative to the theoretical value. Results of X-ray analysis and measurements made with the use a scanning electron microscope showed that the obtained powder had an average particle diameter in the range of 2 to 3 nm.

### Practical Example 3

A 2-liter reactor, which was cooled with a flow of water, was loaded with gaseous BF₃ and gaseous NH₃ supplied simultaneously in equal volumes at a flow rate of 0.7 liter/min. The reaction was carried out in the cooled reactor for 3 hours under the atmospheric pressure, whereby 650 g of a white, friable powder was obtained. The obtained complex was subjected to X-ray analysis that confirmed that the product comprised an NH₃.BF₃ complex.

The obtained 650 g of the powdered NH₃.BF₃ complex were loaded into a beaker made from a pyrolytic graphite, and the beaker was inserted into a stainless-steel container, which, in turn, was placed into an oven (thermostat) heated to 300° C. wherein the container was kept for 5 hours in air under atmospheric conditions. Following this, the container was cooled to room temperature, the product of the complex decomposition was extracted and subjected to X-ray phase analysis. The analysis confirmed that the product of decomposition comprised a mixture of BN and ammonium fluoroborate (NH₄BF₄). This mixture was transferred to a 10-liter capacity polypropylene container where the mixture was combined with 9500 g of deionized water, whereby an aqueous suspension was formed.

Suspended particles were caused to precipitate by centrifugation and dried. The resulting product comprised 19.8 g of BN obtained with 91.2% yield relative to the theoretical value. Results of X-ray analysis and measurements made with the use a scanning electron microscope showed that the obtained powder had an average particle diameter in the range of 2 to 3 nm.

### Comparative Example 1

A beaker made from a pyrolytic graphite was filled with 650 g of the powdered NH₃.BF₃ complex obtained in Practical Example 1, and the beaker was inserted into a stainless-steel container, which, in turn, was placed into an oven (thermostat) heated to 100° C. wherein the container was kept for 5 hours in air under atmospheric conditions. Following this, the container was cooled to room temperature, the product was extracted and subjected to X-ray phase analysis. The analysis showed that the product comprised NH₃.BF₃, which testified to the fact that the NH₃.BF₃ complex was not decomposed.

### Comparative Example 2

A beaker made from a pyrolytic graphite was filled with 650 g of the powdered NH₃.BF₃ complex obtained in Practical Example 1, and the beaker was inserted into a stainless-steel container, which, in turn, was placed into an oven (thermostat) heated to 350° C. wherein the container was kept for 5 hours in air under atmospheric conditions. Following this, the container was cooled to room temperature and opened. Observation revealed that a part of the product deposited on the inner walls of the beaker and the oven. Analysis of the deposition confirmed that the deposited material comprised a mixture of BN and NH₄BF₄.

This decomposition product was transferred to a 10-liter capacity polypropylene container where the mixture was combined with 9500 g of deionized water, whereby an aqueous suspension was formed.

Suspended particles were caused to precipitate by centrifugation and dried. The resulting product comprised 13.04 g of BN obtained with 62% yield relative to the theoretical value.

Thus, it has been shown that the invention provides a new, reliable, safe, and simple method for synthesis of a boron nitride nanopowder. The proposed method does not require the use of expensive specific equipment; can be carried out with commercially produced and readily available components, which do not need any preliminary chemical treatment; allows control of the reaction speed and output; and produces a BN powder suitable for recrystallization and sintering.

Although the invention has been shown and described with reference to specific examples, it is understood that these examples should not be construed as limiting the areas of application of the invention and that any changes and modifications are possible provided that these changes and modifications do not depart from the scope of the attached patent claims. For example, reactors for obtaining the NH₃.BF₃ complex may have different modifications. Inert gases other than those mentioned in the examples can be used in the process. BN can be separated from 3NH₄.BF₄ by methods other than centrifugation of an aqueous suspension that contains BN particles.

1. A method for synthesis of boron-nitride nanopowder comprising the steps of:
conducting a reaction between gaseous ammonia and a gaseous boron trifluoride for obtaining a boron trifluoride-ammonia complex in a powdered form;
thermally decomposing the obtained boron trifluoride-ammonia complex into boron nitride nanoparticles and ammonium tetrafluoroborate; and
and obtaining a boron nitride nanopowder by separating boron nitride nanoparticles from ammonium tetrafluoride.

2. The method of claim 1, wherein the reaction between gaseous ammonia and a gaseous boron trifluoride is carried out in a cooled reactor under the atmospheric pressure.

3. The method of claim 2, wherein the step of thermally decomposing the obtained boron trifluoride-ammonia complex into boron nitride nanoparticles and ammonium tetrafluoroborate is carried out in accordance with the following scheme:
4NH₃.BF₃→BN+3NH₄.BF₄

4. The method of claim 1, wherein the step of thermally decomposing the obtained boron trifluoride-ammonia complex into boron nitride nanoparticles and ammonium tetrafluoroborate is carried out at a temperature in the range of 125 to 300° C.

5. The method of claim 4, wherein the reaction between gaseous ammonia and a gaseous boron trifluoride is carried out in a cooled reactor under the atmospheric pressure.

6. The method of claim 5, wherein the step of thermally decomposing the obtained boron trifluoride-ammonia complex into boron nitride nanoparticles and ammonium tetrafluoroborate is carried out in accordance with the following scheme:
4NH₃.BF₃→BN+3NH₄.BF₄

7. The method of claim 1, wherein the step of thermally decomposing the obtained boron trifluoride-ammonia complex into boron nitride nanoparticles and ammonium tetrafluoroborate is carried out in a gaseous atmosphere selected from air and inert gas.

8. The method of claim 1, wherein the reaction between gaseous ammonia and a gaseous boron trifluoride is carried out in a cooled reactor under the atmospheric pressure.

9. The method of claim 8, wherein the step of thermally decomposing the obtained boron trifluoride-ammonia complex into boron nitride nanoparticles and ammonium tetrafluoroborate is carried out in accordance with the following scheme:
4NH₃.BF₃→BN+3NH₄.BF₄

10. The method of claim 9, wherein the step of thermally decomposing the obtained boron trifluoride-ammonia complex into boron nitride nanoparticles and ammonium tetrafluoroborate is carried out at a temperature in the range of 125 to 300° C.

11. The method of claim 3, wherein the step of thermally decomposing the obtained boron trifluoride-ammonia complex into boron nitride nanoparticles and ammonium tetrafluoroborate is carried out at a temperature in the range of 125 to 300° C.

12. The method of claim 6, wherein the step of thermally decomposing the obtained boron trifluoride-ammonia complex into boron nitride nanoparticles and ammonium tetrafluoroborate is carried out in a gaseous atmosphere selected from air and inert gas.

13. The method of claim 1, wherein the step obtaining a boron nitride nanopowder by separating boron nitride nanoparticles from ammonium tetrafluoride comprises the step of forming an aqueous suspension by mixing deionized water with the boron nitride nanoparticles and ammonium tetrafluoroborate obtained in the step of thermally decomposing the obtained boron trifluoride-ammonia complex, and separating boron nitride nanoparticles by subjecting the suspension to centrifugation.

14. The method of claim 10, wherein the step obtaining a boron nitride nanopowder by separating boron nitride nanoparticles from ammonium tetrafluoride comprises the step of forming an aqueous suspension by mixing deionized water with the boron nitride nanoparticles and ammonium tetrafluoroborate obtained in the step of thermally decomposing the obtained boron trifluoride-ammonia complex, and separating boron nitride nanoparticles by subjecting the suspension to centrifugation.

15. The method of claim 11, wherein the step obtaining a boron nitride nanopowder by separating boron nitride nanoparticles from ammonium tetrafluoride comprises the step of forming an aqueous suspension by mixing deionized water with the boron nitride nanoparticles and ammonium tetrafluoroborate obtained in the step of thermally decomposing the obtained boron trifluoride-ammonia complex, and separating boron nitride nanoparticles by subjecting the suspension to centrifugation.
